(19) United States
(12) Patent Application Publication
(10) Pub. No.: US 2009/0187831 A1
(43) Pub. Date: Jul. 23, 2009

(54) Integrated Electronic Mail and Instant Messaging System

(76) Inventors: Shahzad Tiwana, Los Angeles, CA (US); Sean Rad, Los Angeles, CA (US)

Correspondence Address: COURTNEY STANIFORD & GREGORY LLP, P.O. BOX 9686, SAN JOSE, CA, 95157, US

(21) Appl. No.: 11/867,839

(22) Filed: Oct. 5, 2007

Related U.S. Application Data
(60) Provisional application No. 60/828,971, filed on Oct. 10, 2006.

(51) Int. Cl. G06F 3/00; G06F 15/16; G06F 13/00

(52) U.S. Cl. 715/752; 709/206

(57) ABSTRACT

Embodiments of a system for integrating electronic mail and instant messaging applications in a comprehensive communication interface are described. The integrated communication interface is embodied as a web-based communication portal that allows users from a single application and log-in session to download all of their e-mail messages and Instant Messaging (IM) messages from different e-mail and IM accounts, as well as access other communication related services. Users can switch between e-mail and IM type communication within the same application depending on their preference, without the need to switch applications on their client computers. Instant message sessions for one of a plurality of different instant message systems can be opened within a single e-mail portal.

### CROSS-REFERENCE TO RELATED APPLICATIONS

This application is claims the benefit of U.S. Provisional Patent Application No. 60/828,971 entitled “Integrated Communication System,” and filed on Oct. 10, 2006.

### FIELD

Embodiments of the invention relate generally to electronic communication systems, and more specifically, to an integrated communication platform for asynchronous and synchronous messaging protocols.

### BACKGROUND

Text-based communication capabilities have become built-in to a wide variety of different computing devices, such as desktop computers, portable or notebook computers, Personal Digital Assistance (PDA) devices, wireless telephones, cellular phones, network kiosks, and the like. The advent of global computer networks, such as the Internet, has facilitated the establishment of a variety of communication systems that are available to users of such computing devices. These include electronic mail (“e-mail), instant messaging (IM), Internet Chat, and other modes of communication that can be accessed through a variety of web-based, desktop software-based, or embedded applications.

Present communication methods typically involve the use of various different services, protocols and devices. For example, a person might use a workstation or portable computer for e-mail exchange and a cell phone, or other type of mobile communication device, for voice or text message type communication. The increased computing power available in mobile computing devices and the increased multimedia capability of portable computers has led to the availability of many different communication interfaces on virtually all popular electronic devices. These communication interfaces and protocols, however, remain unorganized and separate. In order to effectively communicate with others, a user may need to launch two or three different communication applications, such as e-mail and IM applications in the same or different devices. Even within the same type of communication method, such as IM, different protocols may be used by different vendors, thus making communication among different service users quite difficult.

Most communication services can be divided into asynchronous services, such as e-mail, in which send and reply sequences in a communication session may occur at different times, or synchronous services, such as IM, in which the send and reply sequences occur in real-time or near real-time. In terms of functionality and interface standards, there is a degree of overlap among different communication services, even between synchronous and asynchronous services. However, these services typically run on separate applications and often on separate device platforms, which leaves little opportunity for integration between them. This lack of integration requires users to run multiple separate communication applications, and even use different devices. It also requires users to establish and maintain separate accounts with possibly several different vendors. This results in an unorganized and potentially confusing experience with regard to deployment and use of communication applications, and also introduces vulnerabilities with regard to user privacy and security.

Although some service providers and vendors have attempted to bridge the gap between asynchronous and synchronous services, present integration solutions are incomplete and inefficient because they are typically limited to single protocols or systems available from one or only a few vendors. What is needed, therefore, is a comprehensive communication integration system that allows for cross-protocol and cross-vendor communication using a single application that requires minimal or no client-side application installation.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a computer network system that implements one or more embodiments of a communication interface platform that facilitates integration of e-mail and messaging applications.

FIG. 2 is a system diagram that illustrates the interface between instant messaging servers and an integrated communication interface system, under an embodiment.

FIG. 3 illustrates a web page screen shot showing the detection of an online user, under an embodiment.

FIG. 4 is a web page screen shot illustrating an IM conversation embedded in the body of an e-mail message, under an embodiment.

FIG. 5 illustrates a web page screen shot of an Internet chat room invitation form, under an embodiment.

FIGS. 6A and 6B are flowcharts that illustrate a method of integrating an IM application with an e-mail program, under an embodiment.

FIG. 7 is a flowchart illustrating a method of creating a user account for an integrated communication interface system, under an embodiment.

FIG. 8 is a flowchart that illustrates a method of sending a stored IM or chat conversation to another user through e-mail, under an embodiment.

### INCORPORATION BY REFERENCE

Each publication, patent, and/or patent application mentioned in this specification, including U.S. Provisional Patent Application No. 60/828,971 filed Oct. 10, 2006 is herein incorporated by reference in its entirety to the same extent as if each individual publication and/or patent application was specifically and individually indicated to be incorporated by reference.

### DETAILED DESCRIPTION

Embodiments of a system for integrating electronic mail and instant messaging applications in a comprehensive communication interface are described. In the following description, numerous specific details are introduced to provide a thorough understanding of, and enabling description for, embodiments of the integrated communication interface. The integrated communication system includes an interface that is embodied as a web-based communication portal that allows users from a single application and log-in session to download all of their e-mail messages and IM messages from different e-mail and messaging accounts, as well as access other communication related services. In one embodiment, the communication interface is a web-based application that eliminates the need for any dedicated application software to be installed on the client computer. The interface functionality is provided on as a web-server application and is configured to recognize and leverage overlapping functionality between different communication services to provide a comprehensive communication portal for the user through their client computer or other client device. One skilled in the relevant art will recognize that these embodiments can be practiced without one or more of the specific details, or with other components, systems, and so on. In other instances, well-known structures or operations are not shown, or are not described in detail, to avoid obscuring aspects of the disclosed embodiments.

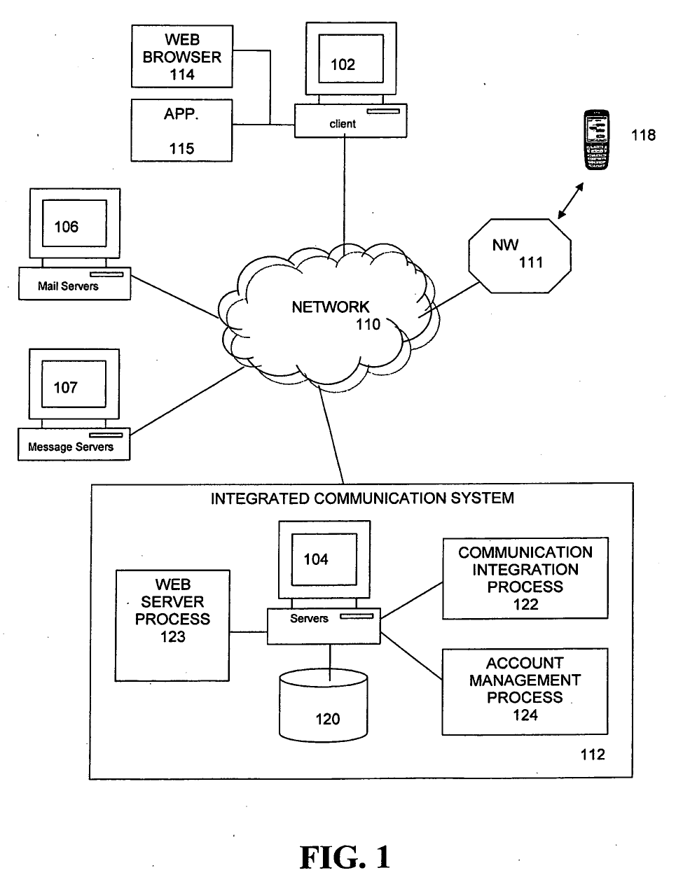

Aspects of the one or more embodiments described herein may be implemented on one or more computers executing software instructions. The computers may be networked in a client-server arrangement, or similar distributed computer network. FIG. 1 illustrates a computer network system 100 that implements one or more embodiments of a communication interface platform that facilitates integration of e-mail and messaging applications. The network environment of FIG. 1 includes multiple communication application servers, such as mail servers 106 and instant message servers 107 all coupled to a data communication network 110. The network environment 100 serves to couple the various server computers to client computers or devices 102 and 118 operated by customers (“users”) of services provided by the entities operating the server computers.

The communication links shown between the network 110 and the various client and server computers shown in FIG. 1 can use any type of communication medium and any communication protocol. For example, one or more of the communication links shown in FIG. 1 may be a wireless link (e.g., a radio frequency (RF) link or a microwave link) or a wired link accessed via a public telephone system or another communication network. The network interfaces between the server and client computers to the network 110 may include one or more routers that serve to buffer and route the data transmitted between the server and client computers. Certain devices, such as servers, may be coupled to a local area network (LAN), which is coupled to network 110.

Client computer 102 may access network 110 in different ways. First, client computer 102 may directly access network 110, for example, by using a modem to access a public telephone network (e.g., a public switched telephone network (PSTN)) that is coupled to network 110. Client computers may be any class of computing device, such as personal computer, workstation, and so on. Another class of client computers is represented by mobile client 118. Mobile client (wireless device ) 118 can be a mobile computing or communication device, such as a notebook computer, personal digital assistant (PDA), mobile phone, game console, or any similar class of mobile computing device with sufficient processing and communication capability that is capable of communicating with other devices via a wireless connection. Mobile client 118 can be coupled to network 110 through a separate network 111, which can be a cellular network in the case where mobile device 118 is a cellular phone. Network 110 may be any type of data communication network using any communication protocol. Further, network 110 may include one or more sub-networks (not shown) which are interconnected with one another. In one embodiment, network 110 comprises the Internet, and may include one or more Wide Area Networks (WAN), Local Area Networks (LAN), or any combination thereof.

In one embodiment, the one or more of the server computers function as a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computers and any available content provider or supplemental server. For this embodiment, client computer 102 may access the Internet 110 through an Internet Service Provider (ISP).

As shown in FIG. 1, an integrated communication system 112 coupled to network 110 includes one or more server computers that execute various functions of an integrated communication interface. This interface includes one or more functional components that perform the tasks of processing messages transmitted to and from client computer 102 and managing account information for different message platforms. As shown in FIG. 1, the integrated communication system 112 includes a communication integration process 122 and an account management process 124. Other similar components can also be included. The communication interface process 122 is configured to detect the online or offline presence of other recognized users across the instant messaging protocols used by the one or more instant messaging servers 107. The other recognized users generally comprise friends or “buddies” of the user who are on one or more “buddy lists” or contact lists of the user. Once detected online, the user can instant message these friends from within the server application, without the need to launch any secondary or host messaging application, such as from the message servers 107.

Each of the processes 122 and 124 may represent one or more executable programs modules that are stored within integrated interface server 104 and executed locally within the server. Alternatively, the server-side processes may be stored on a remote storage 120 or processing device coupled to server 104 or network 110 and accessed by server 104 to be locally executed. In a further alternative embodiment, these processes may be implemented in a plurality of different program modules, each of which may be executed by two or more distributed server computers coupled to each other, or to network 110 separately. Data for any of the applications contained within or associated with messaging applications used by the client computer 102 may be provided by a data store 120 that is closely or loosely coupled to any of the server and/or client computers.

One or more of the server computers also execute a web server process 123, which allows access to users of client computer 102 to access the integrated communication system through a web-based interface. The processing components of the system are thus available for execution on servers 104 and in most circumstances, no executable code need be installed on the client computer 102. In certain cases, client side modules or applications 115 may be installed on the client computer for local execution, depending upon implementation requirements.

Each of the client and server computers shown in FIG. 1 may be embodied on one or more circuits or machines that include at least a central processing unit (CPU) coupled through a bus to various functional units, such as memory, arithmetic/logic blocks, and input/output (I/O) interfaces. The I/O interfaces can be connected directly or indirectly to one or more on-board or off-board peripheral devices, such as disk drives, communication devices, and so on. The CPU can also be coupled to a network controller, which provides access to network 110 through a network port. The computers are programmed using instructions stored at different times in the various computer-readable media.

For purposes of illustration, programs and other executable program components are illustrated herein as discrete blocks, although it is understood that such programs and components reside at various times in different storage components of the computer, and are executed by the computer's processor. For this purpose, the terms “components,” “modules,” “programming blocks,” and so on are used interchangeably to refer to software or firmware programs, or hardware or firmware logic circuits that are configured to execute specific computer-implemented processes. Thus, the systems and procedures described herein can be implemented in hardware or a combination of hardware, software, and/or firmware. For example, one or more application specific integrated circuits (ASICs) can be programmed to carry out the systems and procedures described herein.

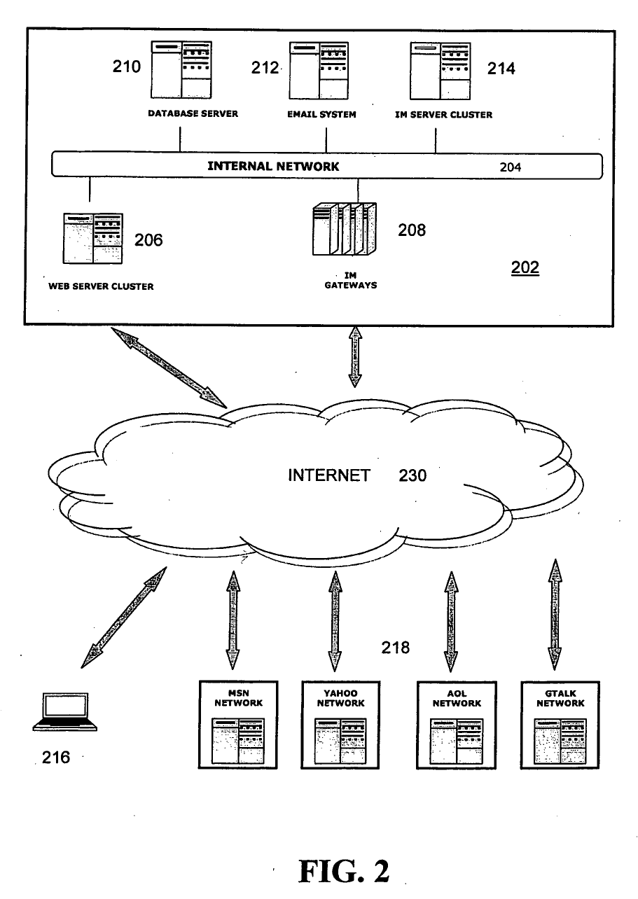

In one embodiment, the integrated communication system 112 functionally couples e-mail and instant messaging server computers in a web-based application for a user computer. FIG. 2 is a system diagram that illustrates the interface between instant messaging servers and an integrated communication system, under an embodiment. As shown in FIG. 2, the integrated communication system 202 is a system that comprises multiple processing components and is coupled to a user computer 216 and a plurality of instant messaging networks 218 over the Internet 230. The integrated communication interface system 202 includes an e-mail system 212 and IM server cluster 214 to provide electronic mail and instant messaging capability for the user computer 216. A set of IM gateways 208 provide an interface for each of the different external IM networks 218 to the system 202. A database server 210 stores user account data for use by the e-mail and IM server systems for a number of different users. An internal network 204 couples the functional components to one another within system 202, and the web server cluster 206 provides a web-based interface to the user computer 216.

The e-mail system 212 is a standard store and forward system that allows users to compose, send, store, and receive text or graphic based messages over network 230. For the Internet embodiment shown in FIG. 2, the e-mail system is based on the Simple Mail Transfer Protocol (SMTP). In one embodiment, the e-mail system 212 supports pulling in e-mail messages from any number of external e-mail accounts and supports both the Internet Message Access Protocol (IMAP), and the Post Office Protocol (POP) for all of the users of system 202. The IMAP protocol is a method of accessing e-mail or bulletin board messages that are kept on the mail server of system 212, and allows a client e-mail program to access the remote message stores as if they were local data stores.

As shown in FIG. 2, the system 202 provides IM capability to the user through IM server cluster 214 and IM gateways 208. In general, instant messaging requires an instant messaging client that connects to an instant messaging service. Instant messaging differs from the electronic mail messaging scheme provided by e-mail system 212 in that the IM conversations happen in real-time. Alternatively, other synchronous messaging systems can be used, such as Internet Relay Chat (IRC) and other similar systems.

As shown in FIG. 202, a web server cluster 206 provides a web-based interface for a user through a web browser executing on user computer 216. In one embodiment, the integrated communication interface system provides a web-based communication application that integrates a plurality of different IM services 218 with an e-mail system 212. This application is available through the web server accessed by the web browser on the client computer. This application allows a user to communicate with any number of other user's (“senders”) during any e-mail or IM messaging session. The communication application detects the online/offline presence of a number of users across the major instant messaging protocols, such as America Online® (AOL/AIM), ICQ, Microsoft® (MSN), Yahoo®, Google® GTalk, and others.

Each of the IM systems 218 of FIG. 2 are assumed to be different types of synchronous communication platforms or use different protocols or conventions for the same type of synchronous communication method. The IM gateways 208 provide a system for reconciling any differences among these messaging systems so that an integrated communication interface based on the e-mail system 212 can be used for communication with users on these different systems.

The integration of IM gateways 214 and e-mail system 212 in system 202 allows for the comprehensive integration of many different types of messaging systems among different users in an e-mail application accessed by the user through a single web-based protocol through web server cluster 206. This system allows a user to receive an e-mail message from a user, detect whether the user is online through any one of a number of IM systems, participate in an IM or chat session with that user, and append the text of the IM or chat session with the e-mail message. The IM gateways 208 contain the necessary interface code to adapt or integrate IM messages from the native format of the external IM systems 218 to the e-mail system 212. In general, an IM system has two main control functions, one is to manage the presence information for the users, and the second is to manage the message content. In one embodiment, each of the IM gateways 208 adapts the relevant parameters related to these functions for each external IM system to the standards of system 202. Examples of such parameters include defining groups, managing contact lists, adding/deleting contacts, formatting messages, defining user privileges/characteristics, and so on. Each gateway is specifically tailored for its respective external IM system based on these and any other appropriate parameters. The external IM systems 218 illustrated in FIG. 2 are intended primarily as examples, and other IM or synchronous communication systems are also possible. As new IM systems are developed, or existing IM systems are modified, gateways 208 can be modified or new ones can be added to accommodate these new external IM systems. Any number of protocols and IM systems can be supported, and the gateways can be modified or added to accommodate additional IM accounts as these IM systems are developed.

System 202 of FIG. 2 provides a platform for which one or more IM or chat sessions can be opened up concurrently with an e-mail exchange and account and contact information for one or both participants can be linked in for detection of presence. The IM gateways 208 can adapt the IM messages for any of the external IM sites from within system 202 and adapt them for use with e-mail system 212. For example, if a user initiates an IM message through a web browser on user computer 216, this is input to system 202 through web server cluster 206. The message is then sent to IM server cluster 214, which determines the type of IM message it is based on service identifiers or other mechanisms. The IM message is then transmitted to the appropriate IM gateway 208 and then out to the corresponding external IM network-218 over the Internet 230.

The integration of synchronous (IM or chat) messages with e-mail (asynchronous) communication is provided to the user in a comprehensive and efficient web interface. When an e-mail message is received by a user, the online/offline presence of the e-mail sender relative to the user is automatically detected by the system, and an icon of the appropriate messaging protocol representing the sender is displayed in the display area of the e-mail or other messaging window of the user. This allows the receiver to initiate an IM session with the sender. In one embodiment, the online/offline presence of senders in the system is only displayed if a sender is a recognized friend of the user for privacy and security reasons. This can be accomplished by validating the sender against a buddy or friend list of the user, or any similar validation method. Once a validated sender is detected, the user can send an instant message to the sender from within the communication application. This prevents the need for the user to relaunch the actual IM or other messaging application used by the sender.

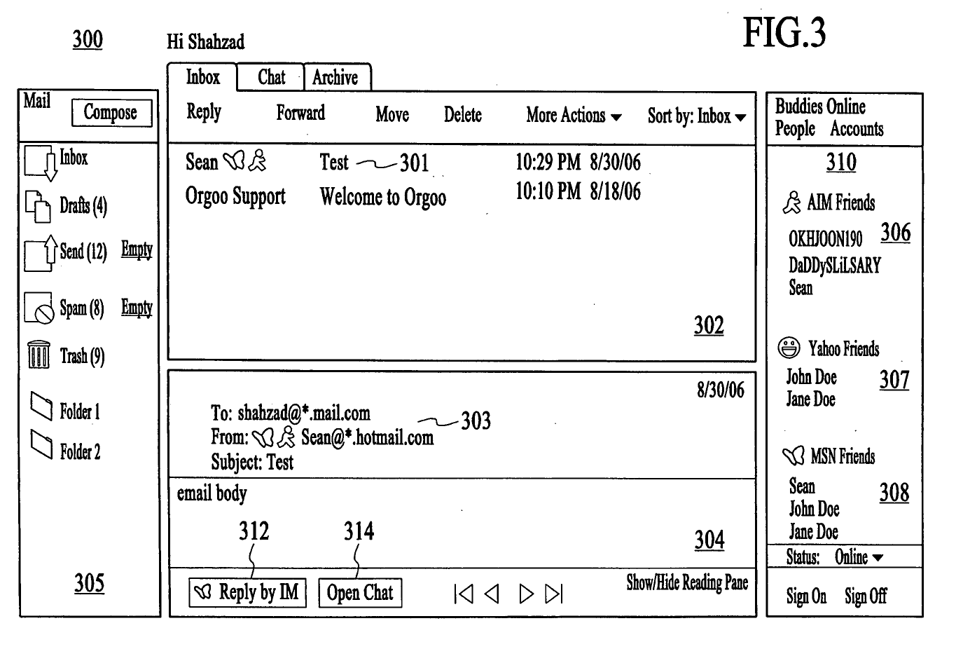

FIG. 3 illustrates a web page screen shot showing the detection of an online user, under an embodiment. Web page 300 represents a typical e-mail program display page for that includes a mail management display area 305 that allows a user to compose, view, store, delete and perform other actions on mail messages within the system. An inbox display area 301 displays e-mail header information for e-mail messages in the inbox, such as sender name, subject, send date and time, and so on. Web page 300 also includes an e-mail message display area that displays a selected e-mail message and includes the message text display area 304 and a header area 303 that shows the sender ID, receiver ID and e-mail subject or title. For the embodiment of FIG. 3, the web page 300 also includes a contact list display area 310 that displays friends or buddy lists maintained by one or more IM services used by the user and available through the system 202. For FIG. 3, the web page 300 illustrates an account held by an e-mail user “Shahzad” who has friends' lists for users if the AIM system 306, the Yahoo system 307, and the MSN system 308. These friends lists specify the names or identifiers for friends who are authorized or recognized by the user as validated or regular people to exchange messages with in the respective IM system 218. The friends can be referenced and listed by actual user names or by nicknames or pseudonyms defined by the systems or the users themselves. As shown in FIG. 3 the IM system or systems utilized by the e-mail sender are automatically detected and displayed through icons or similar mechanisms in the e-mail system. For example, the sender of the e-mail message 304 “Sean” is present in the user's friends lists for AIM and MSN. In this case, the icons for these services are displayed next to the sender's name in both the inbox 302 and the message header area 303. The system can be configured to find the sender under other nicknames or ID's in any of the possible messaging services. The online or offline status of the sender is also automatically detected by the system. This allows the e-mail receiver to initiate an IM or chat session with the user through command buttons 312 and 314. This allows an IM session utilizing the sender's IM protocol to be opened from within the e-mail application window.

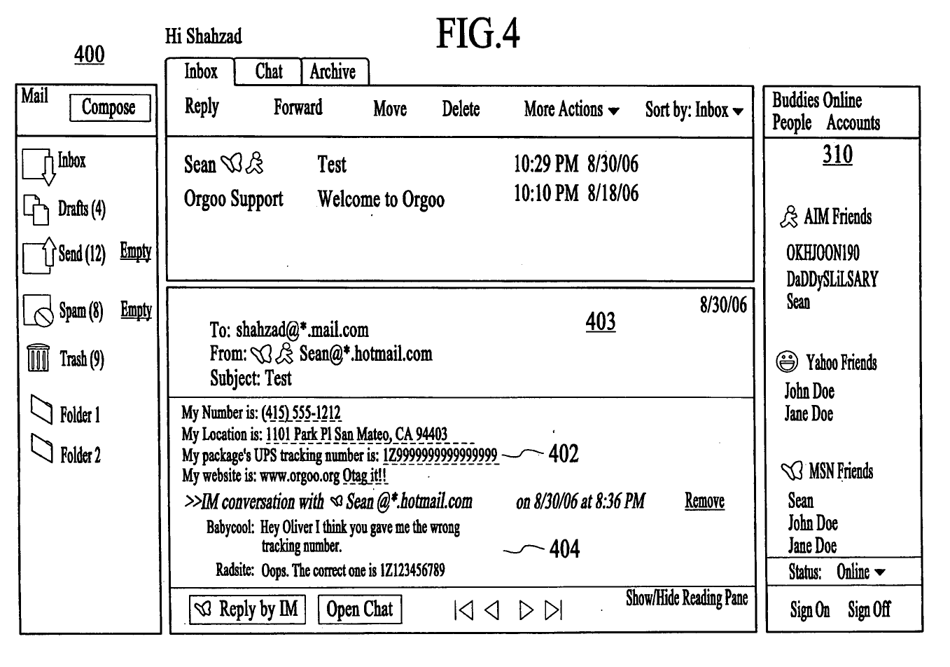

In one embodiment, the communication integration system allows e-mail and IM or chat sessions to be displayed concurrently or in an overlapped fashion in the web page of the e-mail system. FIG. 4 is a web page screen shot illustrating an IM conversation embedded in the body of an e-mail message, under an embodiment. As shown in web page 400 of FIG. 4, within e-mail display window 403, the text of a received e-mail message is displayed for receiver (Shahzad). Because the sender (Sean) is recognized to be on the receiver's friends list for both AIM and MSN, an IM session using either service can be opened within the e-mail application. This is illustrated as IM exchange 404, which is displayed in the same display window as the e-mail message 402. For the example of FIG. 4, the IM session utilizes the MSN service, as shown by the MSN logo next to sender's name.

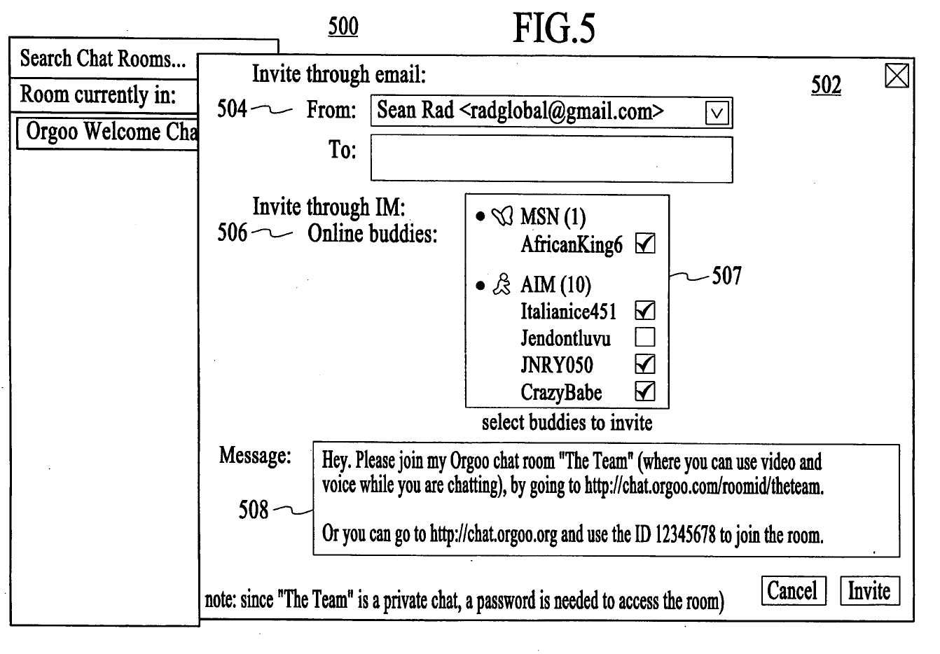

Other types of synchronous communication protocols can also be utilized within the integrated communication system. One such example is an online chat protocol. FIG. 5 illustrates a web page screen shot of an Internet chat room invitation form, under an embodiment. As shown in web page 500 an invitation to participate in an online chat session can be sent through an e-mail message 504, or it can be sent through an instant message 506. The message display window 508 provides an input area for the text of the invitation message. The chat system allows a user to invite other users to a chat room regardless of the e-mail or IM system. Thus, as shown in FIG. 5, friends list 507 contains both MSN and AIM users. The chat session can include users from both of these IM systems. The chat session can be text-based, audio-based, video-based, or any combination thereof. The text contents of the chat session can be linked with any previously saved e-mail or IM message. In one embodiment, audio or video based chat sessions can be first transcribed to text prior to linking.

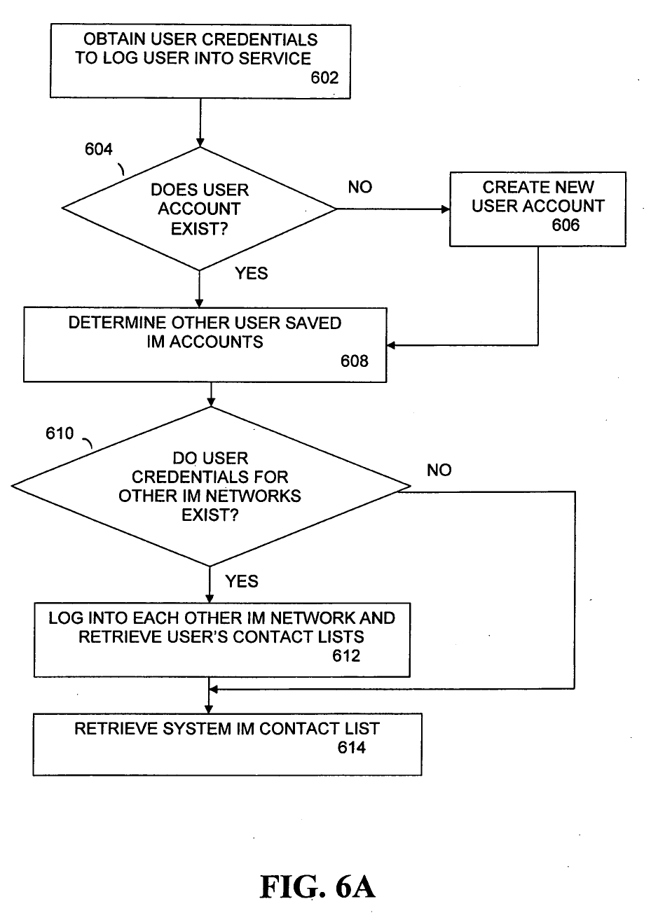

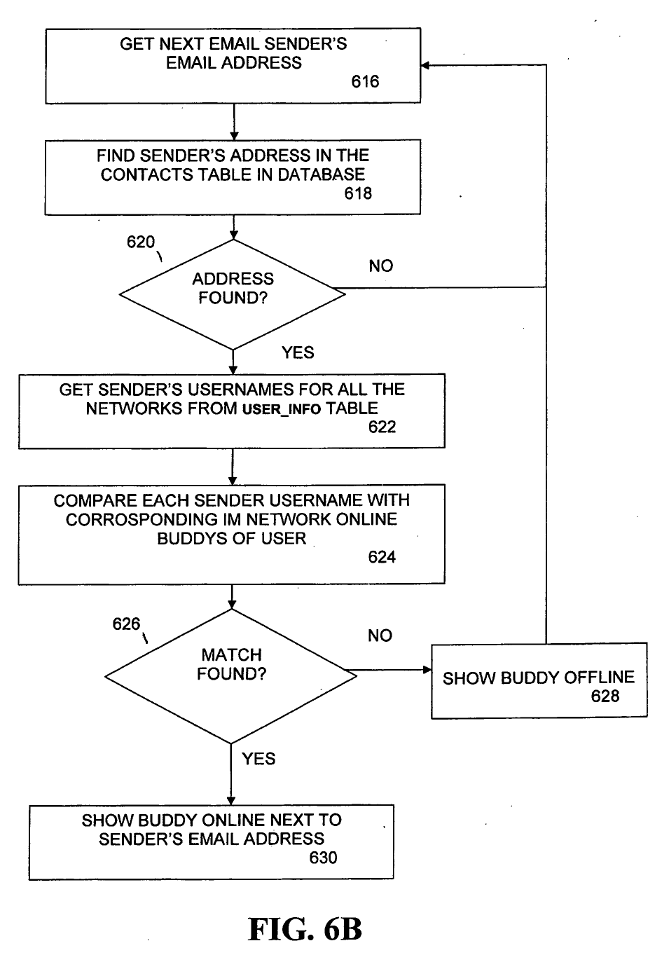

FIGS. 6A and 6B are flowcharts that illustrate a method of integrating an IM application with an e-mail program, under an embodiment. The user accesses the system by providing valid credentials during a log-in to the application web page, block 602 of FIG. 6A. The system determines whether a user account exists, block 604. This is typically performed by searching a user database maintained in a server computer through an account management process 124. If no user account exists, the user is given the opportunity to create a new account, block 606. Once the user account is created in block 606 or confirmed in block 604, the process determines whether there are any other user saved IM accounts, block 608. This process utilizes the database server 210 to determine whether the user maintains any other IM accounts within the IM server cluster 214 or the external IM networks 218. In block 610, the process determines whether user credentials exist for any of these other IM networks. If such credentials exist, the system logs into each saved IM network and retrieves contact or buddy list information from these networks, block 612. The system then retrieves the contact information for the user from its own user contact list, block 614. The contact information can include any nicknames of the user defined within each system.

In one embodiment, the communication interface process 122 includes processing components that recognize IM messaging protocols and conventions implemented by a variety of different IM vendors. These protocol definitions can be manually input into a database maintained by a server 104 or they can be at least partially automated through intelligent processes that detect known patterns and datatypes. As shown in FIG. 2, the adaptation of protocols for each external IM system 208 is performed by the IM gateways 208 and IM server cluster 214 for the appropriate formatting and routing of IM messages in conjunction with the e-mail system 212.

With reference to FIG. 6B, the process analyzes e-mail messages in order of first to last to obtain the e-mail address for each succeeding e-mail sender, block 616. It then compares against the IM contact list or lists by parsing through the contact names in the contact or buddy lists stored in the database, block 618. If, in block 620 it is determined that the address is found, the process obtains the sender's user names for all of the networks in which the user is logged into, block 622, otherwise the process goes to the next e-mail sender. After the sender's names are obtained, the process compared each sender's user name with the corresponding IM network online buddies of the user, block 626. If a match is found, as determined in block 626, the IM service or an icon for the IM service is shown proximate the sender's e-mail address in the e-mail display area, such as shown in FIG. 3. If no match is found, the buddy is shown to be offline, block 628, and the next sender's e-mail address is obtained, block 616.

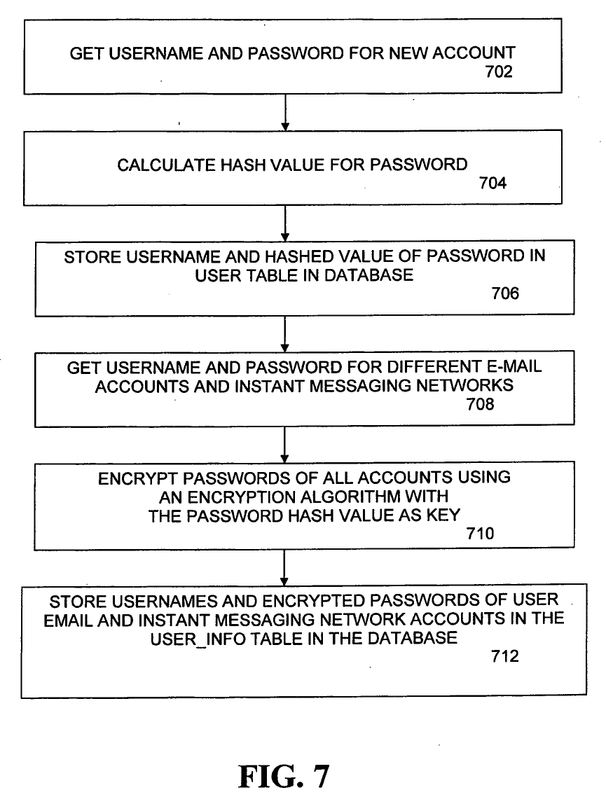

As shown in FIG. 6A, if a user account does not exist in the system, the user is given the opportunity to create an account. FIG. 7 is a flowchart illustrating a method of creating a user account for an integrated communication interface system, under an embodiment. This process is generally performed by the account management process 124. As shown in FIG. 7, the account creation process begins with the user providing a user name and password for the new account, block 702. The user name or user ID and password comprise the user credentials. The user credential information is stored in a database table that has username and password fields. A user_info table in the database has several account specific fields, such as User_Name, Account_Name to store account information (e.g., Yahoo, MSN, etc.), Account_Type to store the type of account (e.g., e-mail or IM), Account_Username to store the user name for the account, and Account_Password to store the encrypted password for the account.

The process automatically calculates a hash value for the password, block 704. In one embodiment, a Message-Digest 5 (MD5) hashing algorithm is used. This is a 128-bit hash value that is employed in a wide variety of security and file integrity applications. An MD5 hash is typically expressed as a 32-character hexadecimal number. Alternatively, any similar type of hash algorithm can be used. The user name and hashed value of the password is then stored in a database maintained by the account management process 124, block 706. The process then obtains the user name and passwords for any other e-mail and IM accounts of the user, block 708. The process then encrypts the passwords of all of these accounts using an encryption algorithm that employs the password hash value as the key, block 710. In one embodiment, the encryption algorithm comprises the Advanced Encryption Standard (AES), which is a block cipher. AES is a symmetric key cryptography system that supports a block size of 128 bits and key sizes of 128, 192, and 256 bits. The user names and encrypted passwords of the user e-mail and IM accounts are then stored in the database in a User-Info, or similar table, block 712. It should be noted that encryption algorithms other than AES can also be used.

As shown in FIG. 4, the integrated communication interface system allows users to participate in online IM conversations during an e-mail session between a user and a friend. The example web pages of FIGS. 3 and 4 contain a command button labeled “Reply by IM.” If this button is selected by a user during an e-mail session, the process will open an IM window under or proximate the e-mail message window, as shown in FIG. 4. All of the IM conversation will be recorded in a temporary file. The process then appends the e-mail to the end of the e-mail text once the IM window 404 is closed.

The web page can also include a “Link” command button. This button causes the process to display the list of all saved and open e-mail, IM, and chat conversations. The IM or chat conversations are appended at the end of a selected conversation once the IM window or chat room window is closed.

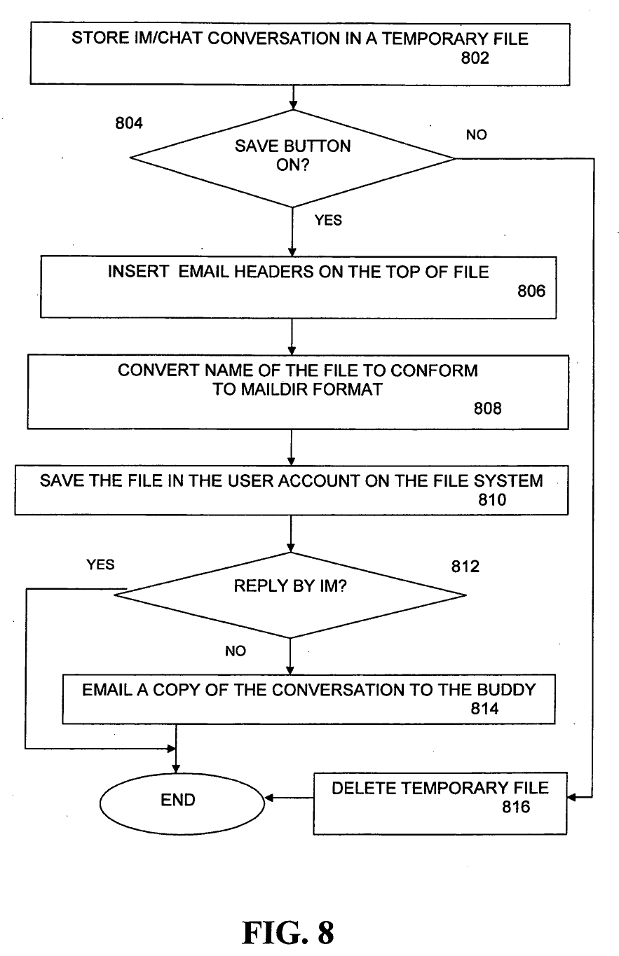

In one embodiment, saved IM or chat conversations, or any other synchronous type of message can be transmitted to another user using the e-mail or other asynchronous application. The chat system allows a user to invite other users to a chat room regardless of the e-mail or IM system. FIG. 8 is a flowchart that illustrates a method of sending a stored IM or chat conversation to another user through e-mail, under an embodiment. In block 802, the system stores an IM or chat conversation in a temporary file. This can be configured to be an automatic event for all synchronous type conversations, or the system can be configured to automatically store only certain types of conversations or only upon user selection. Temporarily stored conversations are stored persistently only if the user elects to do so by selecting a save command. Thus, in block 804, the system checks whether the save button has been selected. If not, the temporary file is deleted, block 816, and the process ends. If the save button is on, certain defined e-mail headers are inserted in the temporary message file, block 806. In one embodiment, the e-mail headers are of the following format:

Content-Transfer-Encoding: quote-printable
Content-Type: text/html; charset=”utf-8”
MIME-Version: 1.0
To = “Receiver Email”
From = “Sender Email”
Subject = “Protocol (service/msn/yahoo/aim/icq) or

Chatroom Name”

Reply-To: “Sender Email”
Date: Date and time
“Custom Headers starting with X like X-Mailer

After the headers are inserted, the name of the temporary file is converted to conform to a MailDir, or similar format, block 808. The file is then saved in the user account in the file system, block 810. In block 812 it is determined whether the buddy replies by IM. If not, the process ends; otherwise, the system e-mails a copy of the conversation to the buddy, block 814. The contents of the chat session can be transcribed to text and linked with any previously saved e-mail or IM message. This may done by a link or attach command that allows a user to search and find previous e-mail messages to associate with the chat session.

In one embodiment, the integrated communication system allows user to create and participate in multiple public or private chat rooms. Each chat room is assigned its own URL (Uniform Resource Locator). This allows each user to access the chat room without having a system account or logging in. If a participant of a chat room is logged in to the system, and thus to one or more of their e-mail and IM accounts, the user may invite other contacts to that chat room through e-mail or IM. Once the user selects the “Invite” command button, a form appears allowing the user to send an e-mail invitation from one of their registered e-mail accounts. The user is also presented with a list of online buddies on their registered IM accounts, and can select buddies from the list to send an IM invitation to the chat room. The user can then compose and send a custom message that contains the URL of the chat room. This can be sent via e-mail if e-mail addresses are given, or an IM if buddies are selected. When the invitee clicks on the URL, he or she is then taken to the chat room in the browser window.

The integrated communication interface provides a platform that consolidates multiple different synchronous and asynchronous communication applications into a single web-based application allowing them to run simultaneously and as a single application. Any number of different IM systems can be used in conjunction with the e-mail system to provide a mechanism for users to open and participate in IM or chat sessions during e-mail exchanges. Contact lists for the users are analyzed and the online/offline presence of users is automatically detected to provide a convenient mechanism for integrated communication in a manner that maintains the privacy of existing user accounts. This overall system provides the user with faster. access to his or her communication services and accounts and provides a more efficient means of communication with other users. Users can switch between e-mail and IM type communication within the same application depending on their preference, without the need to switch applications on their client computers. Through the integrated communication interface, disparate communication services and modes of communication are effectively packaged as a single service, yet maintain the inherent advantages of their native protocols.

Aspects of the integrated communication system and interface described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the integrated communication system include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the integrated communication system and interface is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the application integration system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the integrated communication system are presented below in certain claim forms, the inventors contemplate the various aspects of the methodology in any number of claim forms. For example, while only one aspect of the system is recited as embodied in machine-readable medium, other aspects may likewise be embodied in machine-readable medium. Accordingly, the inventors reserve the right to add additional claims after filing the application to pursue such additional claim forms for other aspects of the described systems and methods.

What is claimed is:

1. A method of integrating an electronic mail service with a plurality of instant messaging services each having a separate messaging protocol, the method comprising:
providing access in the electronic mail service to user subscription data in one or more of the plurality of instant messaging services, the subscription data comprising user profile data and identifiers for one or more friends for sending and receiving messages;
providing an electronic mail user interface to the user for sending and receiving electronic mail messages to and from the one or more friends;
detecting whether a friend is presently online or offline on any of the plurality of the instant messaging services, if the user has saved the friend's instant messaging identifiers against his or her contact in the contacts database;
displaying the online or offline status of the friend in the electronic mail message user interface; and
providing instant messaging communication between the user and the friend through the electronic mail user interface using a respective messaging protocol of the instant messaging service.

2. The method of claim 1 further comprising registering each separate messaging protocol with the electronic mail service.

3. The method of claim 2 further comprising:
storing the user profile data in a first database accessible to the electronic mail service; and
storing the identifiers for the one or more friends in the contacts database.

4. The method of claim 3 wherein the profiles of the one or more friends are obtained by respective databases maintained by the one or more of the plurality of instant messaging services.

5. The method of claim 3 further comprising:
storing a transcript of any instant messaging communication between the user and the friend during an instant messaging exchange between the user and the friend initiated as a reply by the instant message for an electronic mail; and
embedding the transcript of the instant messaging communication in the body of the saved electronic mail message stored with the user and transmitting the same instant message as a standard email to the friend after the instant message exchange is over.

6. The method of claim 4 further comprising providing access to a public or private chat room for the user and the friend during the electronic mail exchange.

7. The method of claim 6 further comprising:
storing a transcript of any chat communication between the user and the friend;
providing a means for the user to locate and select an electronic mail message to associate with the chat communication; and
embedding the transcript of the chat communication in the selected electronic mail message.

8. The method of claim 3 wherein the plurality of instant messaging services are selected from the group consisting of: AOL/AIM, ICQ, MSN, Yahoo, and GTalk.

9. A method of integrating a plurality of separate online messaging systems in an electronic mail (e-mail) interface, comprising:
receiving user credentials on the e-mail interface to validate the user to the e-mail communication system using the e-mail interface;
if the user is validated, accessing a first database to determine which online messaging systems of the plurality of separate online messaging systems that the user has an account to derive a list of subscribed messaging systems;
storing a list of identifiers of friends of the user in the contacts database;
logging onto each of the subscribed messaging systems to retrieve a friend list from each subscribed messaging system for the user;
comparing an identifier of a mail sender or recipient in an e-mail exchange with the user through the e-mail interface by comparing respective identifiers stored in the friend list with the contacts database; and
initiating an instant messaging session with the mail sender or recipient during an e-mail transaction if the identity of the mail sender or recipient matches in the contacts database, using a native instant messaging protocol.

10. The method of claim 9 further comprising displaying an icon representing the instant messaging identifier for the friend adjacent to the icon representing the e-mail identifier for the friend in the user interface for the e-mail communication system.

11. The method of claim 9 further comprising:
storing a transcript of any instant messaging communication between the user and the friend initiated as a result of replying by instant message to an email exchanged between the user and the friend; and
embedding the transcript of the instant messaging communication in the electronic mail message saved with the user and transmitting the same instant message as a standard email to the friend after the instant message exchange is over.

12. The method of claim 1, wherein if the user is not validated, the method further comprises:
displaying a user interface through which the user can create an account;
receiving user credentials and account information for other messaging systems through the interface; and
storing the user credentials and account information for other messaging systems in a database.

13. A machine-readable medium having a plurality of instructions stored thereon that, when executed by a processor in a system, causes the processor to perform the operations of:
providing access in an electronic mail service to user subscription data in one or more of the plurality of instant messaging services, the subscription data comprising user profile data and identifiers for one or more friends for sending and receiving messages;
providing an electronic mail user interface to the user for sending and receiving electronic mail messages to and from the one or more friends;
detecting whether a friend is presently online or offline on any of the plurality of the instant messaging services, if the user has saved the friend's instant messaging identifiers against his or her contact in the contacts database;
displaying the online or offline status of the friend in the electronic mail message user interface; and
providing instant messaging communication between the user and the friend through the electronic mail user interface using a respective messaging protocol of the instant messaging service.

14. The machine-readable medium of claim 13 further having a plurality of instruction that cause the processor to perform the operations of:
registering each separate messaging protocol with the electronic mail service;
storing the user profile data in a first database accessible to the electronic mail service; and
storing the identifiers for the one or more friends in the contacts database.

15. A system comprising:
a web server serving web pages to a web browser executed on a client computer coupled to the system;
an electronic mail (e-mail) server transmitting e-mail messages to and from the client computer to a plurality of additional client computers coupled to the system;
an instant messaging server transmitting instant messages to and from the client computer to the plurality of additional client computers; and
one or more instant messaging gateways configured to adapt the instant messages to a protocol employed by a respective instant messaging protocol utilized by a plurality of external instant messaging service server computers that are coupled to the system.

16. The system of claim 15 wherein the system, client computer, plurality of additional client computers and the external instant messaging service server computers are coupled to one another over the Internet.

17. The system of claim 16 wherein the e-mail server supports pulling in electronic mail messages from any number of external electronic mail accounts and supports both the Post Office Protocol and the Internet Message Access Protocol.

18. The system of claim 17 wherein the plurality of instant messaging services are selected from the group consisting of: AOL/AIM, ICQ, MSN, Yahoo, and GTalk.

19. The system of claim 18 further comprising a module for automatically detecting the online presence one of the additional client computers on one of the instant messaging services.

20. The system of claim 19 further comprising an account management module for validating the transmission of the instant messages to detected online users against one or more contact lists maintained by the client computer.
